(19) United States
(12) Patent Application Publication
(10) Pub. No.: US 2025/0196158 A1
(43) Pub. Date: Jun. 19, 2025

(54) AIR FILTER UNIT AND USE OF THE AIR FILTER UNIT IN A MOTOR VEHICLE

(71) Applicant: MAHLE INTERNATIONAL GMBH, Stuttgart (DE)

(72) Inventors: Markus MICHAEL, Ilsfeld (DE); Florian KLEIN, Bad Liebenzell (DE); Daniel EBERLE, Ludwigsburg (DE)

(21) Appl. No.: 18/978,201

(22) Filed: Dec. 12, 2024

(30) Foreign Application Priority Data
Dec. 18, 2023 (DE) 102023135630.5

(51) Int. Cl. B03C 3/155; B01D 39/16; B01D 46/00; B01D 46/52; B60H 3/06

(52) U.S. Cl. CPC B03C 3/155; B01D 39/1623; B01D 46/0032; B01D 46/521; B60H 3/0608; B01D 2239/0216; B01D 2239/0241; B01D 2239/025; B01D 2239/0407; B01D 2239/0435; B01D 2239/065; B01D 2239/1233; B01D 2275/10; B03C 2201/14; B03C 2201/30

(57) ABSTRACT

An air filter unit is provided and contains,
at least one ionizer, and
at least one filter medium, wherein the at least one ionizer contains at least one discharge electrode, at least one counter-electrode, and at least one voltage source, and wherein the at least one filter medium is downstream of the ionizer, and contains, starting from the upstream side, at least one electret layer, at least one mechanically filtering layer, at least one inner electret layer, and at least one electrically conductive layer. The use of such an air filter unit in a motor vehicle is also provided.

### CROSS-REFERENCE TO RELATED APPLICATIONS

This application claims priority from German Patent Application No. DE 10 2023 135 630.5, filed Dec. 18, 2023, the entirety of which is hereby incorporated by reference herein.

The present invention relates to an air filter unit, in particular for a motor vehicle. The invention also relates to the use of such an air filter unit in a motor vehicle.

To obtain a pleasant and healthy air quality in the passenger compartment of a motor vehicle, particles such as particulate matter and harmful gasses such as volatile hydrocarbons, nitric oxides, ammonia, ozone, or hydrogen sulfide must be removed from the air. The air in urban areas in particular is often polluted with particulate matter. The daily average for particulate matter in cities is often higher than the PM2.5 daily average of 15 μg/m³ prescribed by WHO. This can be extremely hazardous to one's health.

The removal of dust that would otherwise end up in the passenger compartment through the air conditioner is frequently achieved in the prior art with a filter element in an air conditioner that has a fiber filter layer. The available installation space for these air conditioners is limited, however. At the same time, minimum safety requirements must also be met, e.g. preventing the windows from fogging up, requiring a sufficient air supply. To ensure that the air flow is adequate, lower flow resistances, or lower pressure losses in the filter element are necessary. This has the disadvantage that the filter fiber layer is often open-celled. This results in a less effective filtering effect.

Filter media that attract electrostatically charged particles for overcoming this problem have been proposed in the prior art. The filter media are electrostatically charged during the production process, or filter media are used that display a certain electrostatic charge without the need for a separate charging process during their production. Consequently, the dust particles, which are also frequently electrostatically charged, including even very small particles with a diameter of less than 0.3 μm, can initially be effectively filtered out by the electrostatically charged filter medium. Moreover, this does not increase the flow resistance in the filter. By way of example, EP 3056364 A1 discloses the use of a dielectric material such as polypropylene for the filter medium.

Nevertheless, an electrostatic charge obtained in the production process diminishes quickly as the filter medium ages and accumulates increasingly more dust. This means that the electrostatic attraction of the filter medium is only effective at the start of the filter's life cycle, and can diminish significantly after only a few weeks or months, depending on the pollution level in the air. This can expose the passengers to significantly higher pollution levels well before the filter medium would normally be replaced.

The present invention addresses the problem of creating a filter system for purifying air entering the passenger compartment with which sufficient filtration can be achieved for large airflows over longer periods of time.

This problem is solved by the subject matter of the independent claims. Advantageous embodiments are the subject matter of the dependent claims.

An air filter unit obtained with the invention is equipped with at least one ionizer and one filter medium, in which the at least one ionizer contains at least one discharge electrode, at least one counter-electrode, and at least one power source, and in which the at least one filter medium is downstream of the ionizer, and has, starting from the upstream side, at least one outer electret layer followed by at least one mechanical filter layer, at least one inner electret layer, and at least one electrically conductive layer.

The air filter unit obtained with the invention, which has the features of independent claim 1, has the substantial advantage over the prior art that a high level of particle filtration is obtained over the entire service life of the filter medium. Among other things, this is because the electrostatic filtering effect can be maintained over the lifetime of the filter medium.

Another substantial advantage is that the air filter unit remains effective over the entire lifetime of the filter medium, with low pressure losses, such that passengers are exposed to substantially lower pollution levels. The flow resistance in the system is also low, and comparable to that of conventional passenger compartment air filters, which are much less effective.

This is because of the proposed combination of at least one ionizer and at least one filter medium, in which the at least one filter medium, starting at the upstream side, has at least one outer electret layer, followed by at least one mechanically filtering layer, at least one inner electret layer, and at least one electrically conductive layer.

The air filter unit obtained with the invention shall be explained in greater detail below.

The present invention is based on the general concept of designing at least one filter medium for purifying air supplied to the passenger compartment such that, in combination with at least one ionizer, the air can be effectively purified.

An air filter unit is therefore proposed for a vehicle air conditioner, ventilating system, heating system, or combined heating, ventilating and air conditioning system (HVAC system) through which an air flow path passes. The airflow can convey air from outside into the vehicle interior, in particular the passenger compartment. The upstream side is that exposed to the air from the outside. The air filter unit contains at least one ionizer in the flow path, and at least one downstream filter medium.

This means that the air filter unit can contain an ionizer in the flow path, with a downstream filter medium. There can also be two or more ionizers in the flow path, and two or more downstream filter media. It has proven to be particularly advantageous when the air filter unit contains one ionizer in the flow path, and one downstream filter medium.

The at least one ionizer ionizes some of the particles contained in the air. Fundamentally, any of the ionizers known for this to the person skilled in the art can be used. By way of example, ionizers are described in US Pat. No. 2021/0021107 A1 and EP 3056364 A1.

The at least one ionizer contains at least one counter-electrode. This at least one counter-electrode can be on the upstream side in the air path. The at least one counter-electrode can have a grid structure made of an electrically conductive material placed in the air path and through which air can flow.

By way of example, this grid structure can contain steel, in particular stainless steel. The at least one ionizer also contains at least one discharge electrode. This means that the ionizer contains one or more discharge electrodes. It is understood that the at least one counter-electrode is electrically separated from the one or more discharge electrodes. The one or more discharge electrodes can be at different positions in the flow path, e.g. downstream of the at least one counter-electrode, and they can be in the form of electrode rods.

It has also proven to be advantageous when the at least one counter-electrode in the upstream side of the air path is at least 15 mm and no more than 50 mm from the discharge electrodes. The ionizer also has a power source, in particular a high voltage power source connected to the at least one counter-electrode and the one or more discharge electrodes.

An electric field can be generated between the one or more discharge electrodes and the at least one counter-electrode in the flow path. Ideally, a first electrical potential is applied to the one or more discharge electrodes, and a second, different potential is applied to the at least one counter-electrode. The first potential is conceivably a supply potential, and the second is a counter-potential. By way of example, a counter-potential can be obtained in that the at least one counter-electrode is grounded. By way of example, this counter-potential can be a zero potential. Ideally, there is a negative or positive difference in potentials between the at least one counter-electrode and the one or more discharge electrodes when the air filter unit is in use. By way of example, a negative potential difference can be between −5 kV and −15 kV. In this case, a negative corona discharge can be generated at the one or more discharge electrodes.

A negative or positive corona discharge with which gas molecules in the air can be ionized can therefore be generated by the one or more discharge electrodes. It is fundamentally conceivable to generate a direct current, alternating current, or pulsed corona discharge with the ionizer. Either a negative or positive potential can be applied to the one or more discharge electrodes. A negative direct current has proven to be particularly advantageous for generating the corona discharge at the discharge electrode(s). This generates more ions than a positive polarity. The ionized gas molecules obtained thereby can accumulate on the surfaces of the particles in the air, thus charging these particles.

There can also be one or more additional counter-electrodes downstream of the discharge electrodes. By way of example, an additional counter-electrode can be connected to an electrically conductive filter stratum in the at least one filter medium. This will be explained in greater detail below.

After ionizing the air flow in the at least one ionizer, it strikes the at least one filter medium. It is understood that an ionized air flow in this context means nothing other than an electrostatic charging of at least some of the gas molecules in this airflow, and at least some of the pollutants contained therein. The at least one filter medium can be approx. 1 mm to 50 mm, preferably approx. 5 mm to 20 mm from the at least one ionizer.

The at least one filter medium used in the invention has at least one electret layer on the upstream side. The upstream side is understood to be the side that the ionized airflow first strikes after passing through the ionizer, where the at least one outer electret layer in the filter medium is located. An electret is understood by the person skilled in the art to be an insulating material, which has a basically permanent electric charge or dipole, thus generating a basically permanent electrical field around or inside it. Electret layers can be made of polymer fibers, e.g. from polypropylene or polyethylene terephthalate. The at least one outer electret layer has an electrostatic charge. The particle filtration at the at least one outer electret layer is substantially based on the electrostatic filtering effect. One function of the at least one outer electret layer is to absorb larger dust particles.

On the downstream side of the at least one outer electret layer there is at least one mechanically filtering layer. It is clear that the downstream side of the at least one outer electret layer is understood in this context to mean side where the ionized airflow exits the outer electret layer, where at least some of the electrostatically charged particles are removed, and enters the at least one mechanically filtering layer. The at least one mechanically filtering layer is protected by the at least one upstream outer electret layer in that most of the larger particles are caught in this outer electret layer, thus substantially preventing, or at least slowing, a clogging of the at least one mechanically filtering layer, resulting in an increase in the flow resistance. The at least one mechanically filtering layer can be a nonwoven made of nanofibers, in which the filtering effect is obtained in that it contains intermediate spaces, the number and size of which is such that the air can flow through the filtering layer while substantially filtering out particles therein. The at least one mechanically filtering layer thus ensures that a large portion of particulate matter is removed. It therefore necessarily has a somewhat higher flow resistance than the at least one outer electret layer.

Downstream of the at least one mechanically filtering layer there is at least one inner electret layer. This electret layer, like the outer electret layer, can also be made of polymer fibers such as polypropylene or polyethylene terephthalate. The at least one inner electret layer has an electrostatic charge. The particle removal at the at least one inner electret layer is therefore based substantially on an electrostatic filtering effect.

There is at least one electrically conductive layer downstream of the at least one inner electret layer. This can be a metal net, e.g. made of stainless steel. It could also contain at least one stratum of activated carbon.

The at least one outer electret layer, at least one mechanically filtering layer, at least one inner electret layer, and optionally, the at least one electrically conductive layer, can be stacked together, compressed, and laminated, or bonded together at the edges and in points over the surface thereof by ultrasonic welding or thermal welding processes. This is also the case for other layers and strata explained in greater detail below.

A “layer” in the framework of the present invention refers to a coherent unit exhibiting a thickness in the flow direction. Such a layer can comprise a single stratum in this context. This layer could also contain numerous strata, i.e. at least two successive strata of different materials.

The at least one filter medium can be placed in a frame in the air filter unit. This results in a more robust structure. Any of the frames for filter media known to the person skilled in the art can be used for this. The frame can be made of metal or plastic. By way of example, the frame can be made of a thermosetting plastic, or elastomers. The frame is ideally made of a thermoplastic. By way of example, the frame is made of PA6, PA6.6, polypropylene, polyethylene, polystyrene, acrylonitrile butadiene styrene, polyethylene terephthalate, or polyether ether ketone. This frame can also contain additives such as binders, curing agents, etc. Ideally, the frame is reinforced with fiberglass. By way of example, the frame can be made of PA6.6 GF30. Seals can also be placed between the filter medium and the frame.

It has proven to be advantageous when the at least one electrically conductive layer is connected to a counter-electrode in the ionizer. This connection can be advantageously obtained with an electrically conductive stratum that ideally contains activated carbon, or is made thereof. This connection has the advantage that the filter medium can be reactivated to function as an electret stratum. This significantly increases the filtering effect for particulate matter or other particles.

Ideally, a first electric potential is applied to the one or more discharge electrodes when the air filter unit is in use, and a second electric potential, differing from the first, is applied to the at least one counter-electrode and the at least one electrically conductive layer. These are the first and second potentials described above. In the preferred case, where a negative corona discharge is generated at the one or more discharge electrodes, a negative potential difference is obtained between the one or more discharge electrodes and the at least one counter-electrode and at least one electrically conductive layer. A least some of the particles in the airflow are then negatively charged and filtered out in the at least one outer electret layer, polarizing the at least one outer electret layer containing the negatively charged particles and the at least one electrically conductive layer. It is also conceivable to generate a positive corona discharge at the one or more discharge electrodes.

It has also proven to be advantageous when the electrical connection between the at least one electrically conductive layer and a counter-electrode in the ionizer can be switched on and off intermittently, to disconnect the at least one electrically conductive layer from the counter-electrode after a predetermined polarization period has elapsed, and to reconnect it to the counter-electrode after a predetermined depolarization period has elapsed.

Electrical switches of this type are known to the person skilled in the art. By way of example, electromechanical relays can be used for this. Alternatively, the switching can be purely electrical. By way of example, a bipolar transistor such as an insulated-gate bipolar transistor (IGBT) or metal-oxide-semiconductor field-effect transistor (MOSFET) can be used.

This means that the at least one electrically conductive layer is only connected to the counter-potential for a predetermined polarization period. It is obvious that this predetermined polarization period depends on the desired polarization level. This is based on the knowledge that after polarizing the at least one electrically conductive layer, in particular if it is made of activated carbon, the filtration efficiency of the filter medium diminishes slowly, such that power consumption can be reduced through the intermittent disconnection of the electrically conductive layer.

After the depolarization period has elapsed, the at least one electrically conductive layer can be reconnected to the counter-potential, i.e. with a counter-electrode in the ionizer. The polarization and depolarization periods depend on the application and the design of the air filter unit, e.g. the size of the filter medium and the amount of air that is to be filtered.

It has proven to be advantageous when the at least one filter medium downstream of the at least one electrically conductive layer also has a supporting layer. This increases the stability of the filter medium. By way of example, this supporting layer can contain polyester fibers, e.g. made of polyethylene terephthalate, or polyolefin fibers made of polypropylene. This supporting layer can be a spunbond nonwoven fabric, containing polyester fibers or polyolefin fibers, for example.

The supporting layer can also be a spunbond nonwoven fabric made of two different polymer fibers. These are known to the person skilled in the art from DELTA®-BiCo technology. A polymer is typically used in the core of these fibers that differs from that used for the outer layer. They are normally made of continuous filaments from which nonwovens can be made. The core can be polyethylene terephthalate, and the sheath can be polybutylene terephthalate.

Spunbond nonwovens are known to the person skilled in the art. To create these spunbond nonwovens, a polymer is extruded to form fine continuous fibers that are spun and bonded to one another. These spunbond nonwovens preferably have a grammage of approx. 40 g/m² to 100 g/m², more preferably approx. 65 g/m² to 75 g/m². The spunbond nonwoven also preferably has an air permeability (LD) of approx. 3,500 l/(m²s) to 10,000 l/(m²s) at 200 Pa, more preferably approx. 5,500 l/(m²s) to 6,500 l/(m²s) at 200 Pa. The air permeability can be determined according to DIN EN 9237:1995.

Moreover, the spunbond nonwoven has a fiber thickness of approx. 20 μm to 80 μm.

The supporting layer can also contain additives such as binders, curing agents, etc. One example of this is polyurethane. By way of example, the supporting layer can contain a low percentage of additives, i.e. 2% by weight.

The thickness of the supporting layer is approx. 80 μm to 2 mm, more preferably 300 μm to 1 mm.

The person skilled in the art knows how to determine the thickness of this layer, which can be based on DIN EN ISO 9073-02:1997.

It has also proven to be advantageous when the filter medium has a cover nonwoven upstream of the outer electret layer. This cover nonwoven is advantageously a light, open-celled cover nonwoven with a grammage of <50 g/m², in particular approx. 20 g/m², which can filter out the largest dust particles, thus reducing the load to the successive layers without significantly increasing the flow resistance. This also prevents the fibers from separating in the subsequent strata. By way of example, the cover nonwoven can be made of polyester fibers, e.g. polyethylene terephthalate, with a grammage of less than 50 g/m², in particular approx. 20 g/m².

The optional additives contained in the cover nonwoven, such as binders, curing agents, etc., can be the same as those used in the supporting layer.

One or more strata of nonwovens, textiles, knitted fabrics, etc., which have an electrostatic charge, or can be electrostatically charged, can be used to form at the least one outer electret layer. These strata in the at least one outer electret layer can contain melt-blown or spunbond continuous fibers, in particular polyolefin fibers, which are used to obtain a nonwoven. Melt-blown fibers can be obtained by extruding the molten polymer through a die with small holes, and passing hot air over them as they fall to obtain a thermally bonded nonwoven.

The thickness of the at least one outer electret layer is typically approx. 300 μm to 10 mm. This at least one outer electret layer also has intermediate spaces. These are usually open intermediate spaces through which the air can flow, even if the at least one outer electret layer also has some closed intermediate spaces. This at least one outer electret layer preferably has an air permeability (LD) of approx. 300 l/(m²s) to 1,500 l/(m²s) at 200 Pa.

The at least one outer electret layer effectively protects the at least one mechanically filtering layer from becoming clogged with dust particles.

Ideally, an outer electret layer is used that can contain one or more strata. Two or more of layers of the at least one outer electret layer can be stacked together. Each of these two or more layers can also have one or more strata.

The at least one outer electret layer ideally has at least one outer electret stratum that preferably contains two different types of polymer fibers, the first of which is a polyolefin fiber, while the second is a modified polyolefin fiber. A modified polyolefin in this context is understood to mean a polyolefin that contains substituents such as —Cl, —F, —CN.

The first polymer fiber is preferably a polymer that contains polypropylene fibers, and the second is preferably a polymer material such as polyvinylchloride, polytetrafluoroethylene, or a modacrylic.

Modacrylics are known to the person skilled in the art. These are fibers made of acrylonitrile and one or more other components such as vinyl chloride, or vinylidene chloride. The portion of acrylonitrile in these modacrylic fibers is approx. 50% to 85% by weight.

The first polymer fiber could also contain polypropylene. The second polymer fiber could contain at least one polymer material such as polyvinyl chloride, polytetrafluoroethylene, or a modacrylic.

The at least one outer electret stratum that contains polyolefin fibers in the at least one outer electret layer can preferably be a nonwoven made of two different types of polymer fibers, the first of which contains polypropylene, while the second is a modacrylic. The ratio of the first polymer fiber to the second is preferably 50:50 by weight.

The same additives that can be contained in the at least one outer electret stratum that are used in the supporting layer.

It has also proven to be advantageous when the polyolefin fibers in the at least one outer electret stratum in the at least one outer electret layer have a grammage of less than approx. 200 g/m², preferably approx. 100 g/m².

It has also proven to be advantageous when the at least one outer electret stratum that contains polyolefin fibers on the upstream side of the at least one outer electret layer also has at least one outer gradient stratum that preferably contains electrostatically charged polyolefin fibers. In particular, the at least one outer gradient stratum preferably contains electrostatically charged polypropylene fibers.

It has also proven to be advantageous when the at least one outer gradient stratum in the at least one outer electret layer has a grammage of less than approx. 150 g/m², preferably approx. 50 g/m².

The thickness of the at least one outer electret layer is approx. 300 μm to 5 mm. If the at least one outer electret layer also has at least one outer gradient stratum, the thickness of the at least one outer electret layer is preferably 600 μm to 10 mm, comprising an outer electret stratum of approx. 300 μm to 5 mm and an outer gradient stratum of approx. 300 μm to 5 mm.

The at least one mechanically filtering layer can fundamentally contain one or more strata. Any sort of nonwoven, textile, or knitted fabric with which particles can be filtered out mechanically can fundamentally be used for the one or more strata in the at least one mechanically filtering layer.

It has proven to be particularly advantageous if the at least one mechanically filtering layer contains nanofibers with a diameter of approx. 10 nm to 800 nm, preferably approx. 90 nm to 500 nm. In particular, diameters of approx. 90 nm to 120 nm have proven to be advantageous.

This means that if the at least one mechanically filtering layer has just one stratum, it preferably contains nanofibers. If the at least one mechanically filtering layer contains numerous strata, at least one contains nanofibers.

It has also proven to advantageous when the nanofibers are obtained by electrospinning a polymer. The electrospinning process is known to the person skilled in the art. Typically, this involves charging a polymer liquid to obtain an electrostatic repulsion. This stretches the polymer to obtain long fibers from which the nonwoven is obtained.

The stratum or strata containing nanofibers in the mechanically filtering layer can have a grammage of approx. 0.5 g/m² to 3 g/m², preferably approx. 1 g/m².

These one or more strata in the mechanically filtering layer that contain nanofibers are preferably made of a nonwoven that contains polyamide fibers, in particular fibers made of PA6.6, polypropylene fibers, or polyester fibers made of polyethylene terephthalate, or polyvinyl alcohol. The fibers are particularly preferably made of polypropylene. The different strata can be made of the same material, or they can contain different nonwoven materials, e.g. polypropylene and polyamide.

The additives that can be contained in the at least one mechanically filtering layer can be the same as those in the supporting layer.

The thickness of the at least one mechanically filtering layer is typically approx. 1 μm to 0.5 mm. There are also intermediate spaces in the at least one mechanically filtering layer. These are normally open-celled intermediate spaces through which air can flow, even if some of the intermediate spaces are closed. The air permeability (LD) of the at least one mechanically filtering layer is preferably approx. 200 l/(m²s) to 600 l/(m²s) at 200 Pa.

It has also proven to be advantageous when there is at least one intermediate layer between the at least one mechanically filtering layer and the at least one inner electret layer. This intermediate layer forms a support for the at least one mechanically filtering layer. The intermediate layer can be a nonwoven that contains polypropylene or polyester fibers, such that those made of polyethylene terephthalate.

The at least one intermediate layer also preferably has a grammage of less than 50 g/m², preferably approx. 20 g/m².

Any nonwoven, textile, or knitted fabric, etc. that has an electrostatic charge, or can be charged electrostatically, can fundamentally be used for the inner electret layer. The respective strata of the at least one inner electret layer can contain melt-blown or spunbond continuous polymer fibers, in particular polyolefin fibers used to form a nonwoven. Melt-blown fibers can be obtained by extruding a molten polymer through a die with small holes, and passing hot air over them as they fall to obtain a thermally bonded nonwoven.

The thickness of the at least one inner electret layer is typically approx. 300 μm to 10 mm. There are also intermediate spaces in the at least one inner electret layer through which the air that is to be purified can flow, even if some of the intermediate spaces are closed. The air permeability (LD) of the at least one inner electret layer is approx. 300 l/(m²s) to 1,500 l/(m²s) at 200 Pa.

Ideally, the inner electret layer can contain one or more strata. Two or more layers of the at least one inner electret layer can be stacked together. Each of these layers can contain one or more strata.

Ideally, the at least one inner electret layer has at least one electret stratum that contains two different types of polymer fibers, the first of which is a polyolefin fiber, while the second is a modified polyolefin fiber. In this context, a modified polyolefin contains substituents such as —Cl, F, CN.

The first polymer fiber preferably contains polypropylene, and the second preferably contains at least one polymer such as polyvinyl chloride, polytetrafluoroethylene, or a modacrylic. The first polymer could also be polypropylene. The second could contain at least one polymer such as polyvinyl chloride, polytetrafluorethylene, or a modacrylic.

The at least one inner electret stratum that contains polyolefin fibers in the at least one inner electret layer can preferably be a nonwoven made of two different types of polymer fibers, the first of which contains polypropylene, while the second is a modacrylic. In particular, the ratio of the first polymer fiber to the second is preferably 50:50.

The same additives can be used in that at least one inner electret layer that are used in the supporting layer.

It has also proven to be advantageous when the at least one inner electret stratum that contains polyolefin fibers in the at least one inner electret layer has a grammage of less than 200 g/m², preferably approx. 100 g/m².

It has proven to be advantageous when the at least one inner electret layer also has at least one inner gradient stratum upstream of the at least one inner electret stratum that contains polyolefin fibers, which preferably contains electrostatically charged polyolefin fibers. In particular, the at least one inner gradient stratum preferably contains electrostatically charged polypropylene fibers.

It has also proven to be advantageous when the at least one inner gradient stratum in the at least one inner electret layer has a grammage of less than 150 g/m², preferably approx. 50 g/m².

The thickness of the at least one inner electret layer is preferably approx. 300 μm to 5 mm. If the at least one inner electret layer also has at least one inner gradient stratum, the thickness of the inner electret layer is approx. 600 μm to 10 mm, comprising the at least one inner electret stratum of approx. 300 μm to 5 mm, and the at least one gradient stratum of approx. 300 μm to 5 mm.

It has also proven to be advantageous when the at least one electrically conductive layer forms a gas adsorption layer. This means that the at least one electrically conductive layer contains a material, or is made of a material, capable of gas adsorption, e.g. activated carbon. The at least one electrically conductive layer can also contain other components capable of gas adsorption, e.g. zeolites.

It is particularly advantageous when the at least one electrically conductive layer contains activated carbon.

The at least one electrically conductive layer can contain at least two strata, at least one of which contains activated carbon. This electrically conductive layer can also contain two or more strata, each of which contains activated carbon.

The at least one electrically conductive layer can also contain at least two strata, at least one of which is made of activated carbon. The at least one electrically conductive layer can also contain two or more strata, each of which is made of activated carbon.

By way of example, this stratum containing activated carbon can contain granular activated carbon. This stratum could also be made of, or contain, activated carbon fibers. This same stratum could also be made of, or contain, balls of activated carbon. This same stratum could also be made of, or contain, activated carbon granules and fibers. It could also be made of, or contain, activated carbon balls and activated fibers.

The stratum made of, or containing, activated carbon preferably has a grammage of approx. 100 g/m² to 750 g/m², more preferably approx. 300 g/m² to 400 g/m², and in particular approx. 350 g/m².

It has also proven to be particularly advantageous when the at least one electrically conductive layer contains activated carbon and an ion exchanger.

The at least one electrically conductive layer can contain at least two strata, one of which contains an ion exchanger and activated carbon. The electrically conductive layer can also contain two strata, one of which contains activated carbon, while the other contains an ion exchanger. The at least one electrically conductive layer could contain a strata with a granulate made of a mixture of activated carbon and ion exchanger. The at least one electrically conductive layer could also contain a mixture of activated carbon fibers and ion exchanger fibers.

The at least one electrically conductive layer can contain two strata, one of which contains an activated carbon granulate, with a grammage of approx. 100 g/m² to 600 g/m², while the other stratum contains an ion exchanger granulate, with a grammage of approx. 100 g/m² to 390 g/m². In particular, the at least one electrically conductive layer preferably contains two strata, one of which contains an activated carbon granulate, with a grammage of approx. 300 g/m², while the other contains an ion exchanger granulate, with a grammage of approx. 220 g/m².

The ion exchanger can be a cation exchanger, anion exchanger, or a mixed bed ion exchanger. The ion exchanger could also be just an anion exchanger or just a cation exchanger. The ion exchanger is preferably a cation exchanger.

Anion and cation exchangers are known to the person skilled in the art. An anion exchanger can be made of materials with secondary or tertiary amine compounds or quaternary ammonium compounds. Suitable anion exchangers have a poly (styrol-co-divinyl benzene) globule base, functionalized with quaternary ammonium groups.

Cation exchangers can be made of materials containing sulfonic acid groups or carboxyl groups. These cation exchangers can be a plastic resin with a polystyrene base that has sulfonic acid groups permanently bonded to the resin. Suitable cation exchangers have a poly (styrol-co-divinyl benzene) globule base, functionalized with sulfonic acid groups.

Ideally, in strata that contain activated carbon, an ion exchanger, or both activated carbon and an ion exchanger, the activated carbon and/or ion exchanger are secured in place with an adhesive.

Any of the conventional adhesives can be used for this. By way of example, a physically curing adhesive comprising polyamide resin, saturated polyester, ethylene-vinyl acetate-copolymerisate, polyolefins, styrol-butadiene-styrol-block copolymers, styrol-isoprene-styrol-block copolymers or polyimides, or a chemically curing adhesive comprising epoxide resins, polyurethane, phenol-formaldehyde resin, silicone, or cyanoacrylate, can be used. An adhesive comprising polyolefins, epoxy resins, or polyurethane, has proven to be advantageous. In particular, the use of a physically curing adhesive comprising polypropylene has proven to be particularly advantageous. These adhesives can typically be obtained as hotmelt polypropylene.

A stratum containing an ion exchanger preferably also has a grammage of approx. 100 g/m² to 390 g/m², more preferably approx. 220 g/m².

The thickness of the at least one electrically conductive layer is preferably approx. 500μm to 5 mm, more preferably approx. 800 μm to 3 mm. In particular, the thickness of the at least one electrically conductive layer is approx. 2 mm.

Ideally, an electrically conductive layer that contains activated carbon is used, which can contain one or more strata. It is also possible to stack two or more layers of the at least one electrically conductive layer. These two or more layers of the electrically conductive layer can contain one or more strata. It is particularly advantageous to use one electrically conductive layer, however.

It has also proven to be advantageous when the filter medium is pleated. This results in a larger filtering surface area, without significantly increasing the flow resistance.

The present invention is also based on the general concept of creating an air filter unit like that described above for use in a motor vehicle. In particular, this air filter unit is intended for use in a vehicle air conditioner, vehicle ventilation system, vehicle heating system, or a heating, ventilation, and air conditioning system (HVAC system).

Other features and advantages of the invention can be derived from the dependent claims, drawings, and descriptions of the drawings.

It should be understood that the features specified above and described below can be used not only in the given combinations, but also in other combinations or in and of themselves, without abandoning the scope of the present invention.

Therein, schematically:

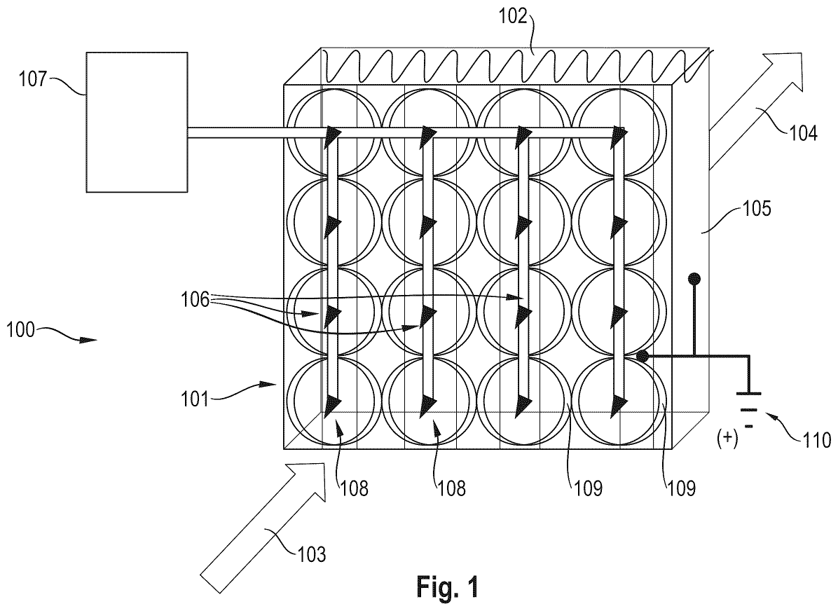

FIG. 1 shows a simplified perspective view of a preferred air filter unit that contains an ionizer and a filter medium;

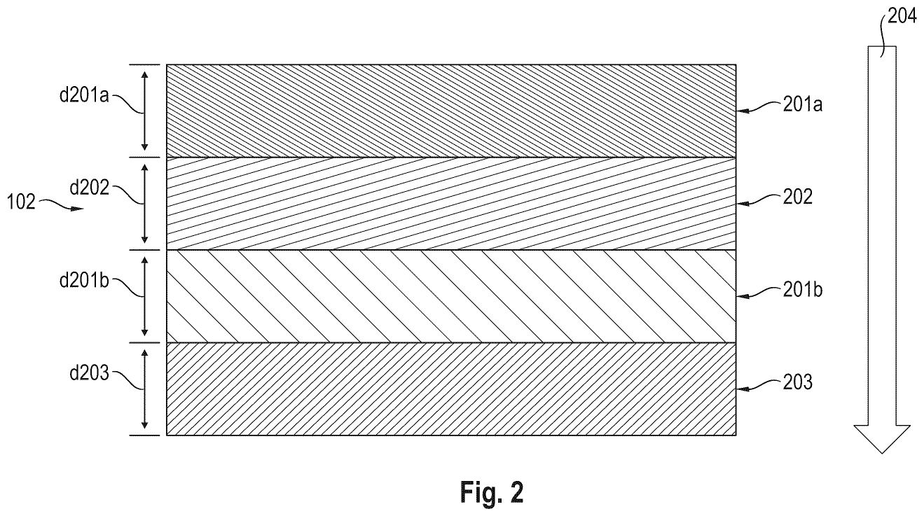

FIG. 2 shows a simplified illustration of a filter medium, and

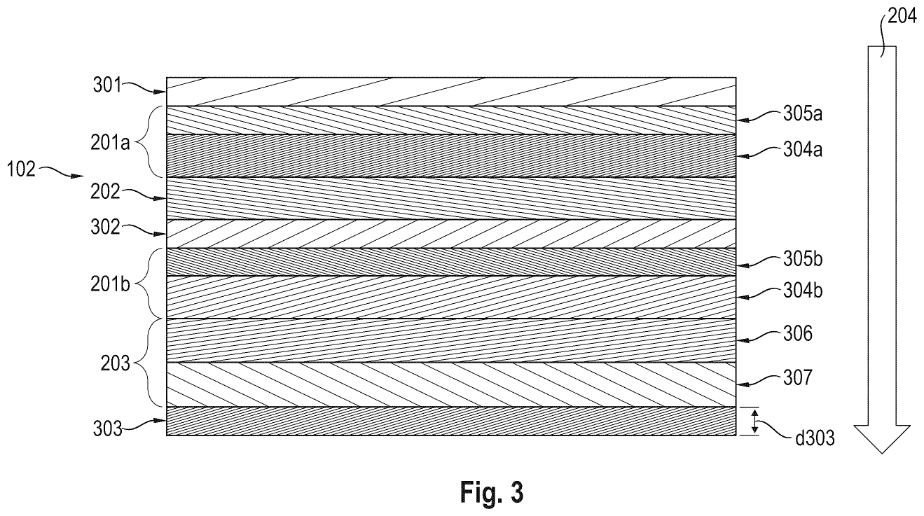

FIG. 3 shows a simplified illustration of a preferred embodiment of a filter medium that has numerous strata.

FIG. 1 shows a highly simplified perspective view of a preferred air filter unit 100, which is installed in a housing 105 for a vehicle air conditioner (not shown). Furthermore, where the air flow enters 103 and exits 104 after passing through the ionizer 101 and the filter medium 102 is schematically illustrated in FIG. 1. It is obvious that the air entering the unit is from outside, and therefore contains particulate matter, in particular in urban areas, that is to be filtered out by the air filter unit 100. This purified air is then supplied to the passenger compartment, not shown in FIG. 1. This airflow preferably passes entirely through the air filter unit. At least some of the gas molecules in the airflow are ionized by the ionizer 101, as indicated in FIG. 1 in a highly simplified manner. Through accumulation of the ionized gas molecules on the surface of the particles in the air, they also acquire an electric charge. This results in an increased particle filtration in the filter medium 102. The structure of the filter medium 102 shall be explained in greater detail in reference to FIGS. 2 and 3. The ionizer 101 in FIG. 1 contains numerous electrodes 108 lying in a plane, which generate a corona discharge and form discharge electrodes, e.g. made of stainless steel. These are indicated by small triangles in FIG. 1. These discharge electrodes 108 are connected to a high voltage source 108 by an electrical conductor 106. The ionizer 101 also contains counter electrodes 109, which form hollow cylindrical counter-electrodes through which air can flow in the embodiment shown in FIG. 1. The filter medium 102 is pleated in FIG. 1, but it could also be flat. The electrically conductive layer of the filter medium 102, which is not shown in FIG. 1, can also be connected to a counter-electrode by another electrical conductor 110. When the air filter unit 100 is in use, the discharge electrodes 108 can receive a first electrical potential from the high voltage source 107, while the counter-electrodes 109, and optionally the electrically conductive layer of the filter medium 102, receive a second, different electrical potential.

FIG. 2 shows the basic form of the filter medium 102, which has an outer electret layer 201a with a thickness d₂₀₁ₐ on the upstream side 204, followed by a mechanically filtering layer 202 with a thickness d₂₀₂, an inner electret layer 201b with a thickness d_{201b}, and an electrically conductive layer 203 with a thickness d₂₀₃.

FIG. 3 shows a preferred embodiment of a filter medium 102. This has a cover nonwoven 301 on the upstream side 204. The cover nonwoven 301 is a spunbond nonwoven containing polyester fibers. The nonwoven grammage is approx. 70 g/m². The polyester fibers have a diameter of approx. 50 μm, and a thickness of approx. 300 μm. This is followed by a downstream outer electret layer 201a, which has a gradient stratum 305a and an outer electret stratum 304a that contains polyolefin fibers. The thickness d₂₀₁ₐ of this outer electret stratum 201a is approx. 1 mm. The outer gradient stratum 305 a is made of electrostatically charged polypropylene fibers with a grammage of approx. 50 g/m². The outer electret stratum 304a is preferably a nonwoven made of two different types of polymer fibers, the first of which is a polyolefin fiber, and the second is a modacrylic fiber. In particular, the ratio of the first to the second is 50:50 by weight. The outer electret stratum 304a has a grammage of approx. 100 g/m².

This is followed by a mechanically filtering layer 202. This is a nonwoven made of polypropylene nanofibers that have a diameter of approx. 100 nm. The thickness d₂₀₂ of the mechanically filtering layer 202 is preferably approx. 200 μm.

This is separated by an intermediate layer 302 from the subsequent inner electret layer 201b, which contains an inner gradient stratum 305b and an inner electret stratum 304b that contains polyolefin fibers. The thickness d_{201b} of this inner electret layer 201b is approx. 1 mm. The inner gradient stratum 305b is made of electrostatically charged polypropylene fibers with a grammage of approx. 50 g/m². The inner electret stratum 304b is preferably a nonwoven made of two different types of polymer fibers, the first of which is a polyolefin fiber, and the second is a modacrylic fiber. The ratio of the first type to the second type is preferably 50:50 by weight. The grammage of the inner electret layer 304b is approx. 100 g/m².

This is followed by an electrically conductive layer 203, which contains two strata 306 and 307. The thickness d₂₀₃ of the electrically conductive layer 203 is approx. 1 mm.

The stratum 306 contains an activated carbon granulate, and has a grammage of approx. 300 g/m², and the stratum 307 contains an ion exchanger granulate, and has a grammage of approx. 220 g/m².

This is followed by a supporting layer 303 that has a thickness d₃₀₃. The supporting layer 303 is a nonwoven made of polypropylene fibers with a grammage of approx. 70 g/m² and a fibers with a diameter of approx. 50 μm. The thickness d₃₀₃ of the supporting layer is approx. 300 μm.

The specification can be readily understood with reference to the following Numbered Paragraphs:

Numbered Paragraph 1. An air filter unit (100), containing
at least one ionizer (101), and
at least one filter medium (102),
wherein the at least one ionizer contains at least one discharge electrode (108), at least one counter-electrode (109), and at least one voltage source (107), and wherein the at least one filter medium (102) is downstream of the ionizer (101), and contains, starting from the upstream side, at least one electret layer (201a), at least one mechanically filtering layer (202), at least one inner electret layer (201b), and at least one electrically conductive layer (203).

Numbered Paragraph 2. The air filter unit (100) according to Numbered Paragraph 1, characterized in that the at least one electrically conductive layer (203) is electrically connected to a counter-electrode in the ionizer (101).

Numbered Paragraph 3. The air filter unit (100) according to Numbered Paragraph 2, characterized in that the electrical connection between the at least one electrically conductive layer (203) and a counter-electrode in the ionizer (101) can be switched on and off, such that the at least one electrically conductive layer (203) can be disconnected from the counter-electrode after a predetermined polarization period has elapsed, and reconnected to the counter-electrode after a predetermined depolarization period has elapsed.

Numbered Paragraph 4. The air filter unit (100) according to any of the preceding Numbered Paragraphs, characterized in that the at least one filter medium (102) has a supporting layer (303) on the downstream side of the at least one electrically conductive layer (203).

Numbered Paragraph 5. The air filter unit (100) according to any of the preceding Numbered Paragraphs, characterized in that the at least one filter medium (102) also has a cover nonwoven (301) on the upstream side of the at least one outer electret layer (201a).

Numbered Paragraph 6. The air filter unit (100) according to any of the preceding Numbered Paragraphs, characterized in that the at least one electret layer (201a) contains at least one outer electret stratum (304a) that contains polyolefin fibers, wherein the at least one outer electret stratum is made of two different types of polymer fibers, the first of which is a polyolefin fiber, and the second is a fiber made of modified polyolefin, wherein the first polymer fiber type is a fiber containing polypropylene, and/or the second polymer fiber type is a fiber containing at least one of the following polymer materials: polyvinyl chloride, polytetrafluoroethylene, or a modacrylic.

Numbered Paragraph 7. The air filter unit (100) according to any of the preceding Numbered Paragraphs, characterized in that the at least one outer electret layer (201a) also has at least one outer gradient stratum (305a) on the upstream side of the at least one outer electret layer (304), wherein the at least one outer gradient stratum contains electrostatically charged polyolefin fibers.

Numbered Paragraph 8. The air filter unit (100) according to any of the preceding Numbered Paragraphs, characterized in that the at least one mechanically filtering layer (202) contains nanofibers, wherein the nanofibers have a diameter of approx. 10 nm to 800 nm, wherein the diameter of the nanofibers is preferably approx. 90 nm to 500 nm.

Numbered Paragraph 9. The air filter unit (100) according to any of the preceding Numbered Paragraphs, characterized in that there is at least one intermediate layer (302) between the at least one mechanically filtering layer (202) and the at least one inner electret layer (201b).

Numbered Paragraph 10. The air filter unit (100) according to any of the preceding Numbered Paragraphs, characterized in that the at least one inner electret layer (201b) contains at least one inner electret stratum (304b) that contains polyolefin fibers, wherein the at least one inner electret stratum is made of two different types of polymer fibers, wherein the first is a polyolefin fiber, and the second is a fiber made of modified polyolefin, wherein the first polymer fiber type is preferably a fiber containing polypropylene, and the second polymer fiber type is a fiber containing at least one of the following polymer materials: polyvinyl chloride, polytetrafluoroethylene, or a modacrylic.

Numbered Paragraph 11. The air filter unit (100) according to any of the preceding Numbered Paragraphs, characterized in that the at least one inner electret layer (201b) also has at least one inner gradient stratum (305b) on the upstream side of the at least one inner electret stratum, which preferably contains electrostatically charged polyolefin fibers.

Numbered Paragraph 12. The air filter unit (100) according to any of the preceding Numbered Paragraphs, characterized in that the at least one electrically conductive layer (203) is also a gas adsorption layer.

Numbered Paragraph 13. The air filter unit (100) according to any of the preceding Numbered Paragraphs, characterized in that the at least one electrically conductive layer (203) contains activated carbon.

Numbered Paragraph 14. The air filter unit (100) according to any of the preceding Numbered Paragraphs, characterized in that the at least one electrically conductive layer (203) contains activated carbon and an ion exchanger.

Numbered Paragraph 15. The air filter unit (100) according to any of the preceding Numbered Paragraphs, characterized in that the filter medium (102) is pleated.

Numbered Paragraph 16. Use of an air filter unit (100) according to any of the preceding Numbered Paragraphs in a motor vehicle.

### LIST OF REFERENCE SYMBOLS

100 air filter unit
101 ionizer
102 filter medium
103 airflow entry direction
104 airflow exit
105 housing
106 electrical conductor supplying the discharge electrodes
107 high voltage source
108 discharge electrodes
109 counter-electrodes
110 other electrical conductor, connected to other counter-electrodes and an electrically conductive filter layer
201a outer electret layer
201b inner electret layer
202 mechanically filtering layer
203 electrically conductive layer
d₂₀₁ₐ thickness of the outer electret layer
d_{201b} thickness of the inner electret layer
d₂₀₂ thickness of the mechanically filtering layer
d₂₀₃ thickness of the electrically conductive layer
204 flow direction of the airflow
301 cover nonwoven
302 intermediate layer
303 supporting layer
304a outer electret stratum, containing polyolefin fibers
304b inner electret stratum, containing polyolefin fibers
305a outer gradient stratum
305b inner gradient stratum
306 first stratum of the electrically conductive layer
307 second stratum of the electrically conductive layer
d₃₀₃ thickness of the supporting layer

1-16. (canceled)

17. An air filter unit, comprising
at least one ionizer, and
at least one filter medium,
wherein the at least one ionizer comprises at least one discharge electrode, at least one counter-electrode, and at least one voltage source, and wherein the at least one filter medium is downstream of the ionizer, and comprises, starting from an upstream side, at least one electret layer, at least one mechanically filtering layer, at least one inner electret layer, and at least one electrically conductive layer.

18. The air filter unit according to claim 17, wherein the at least one electrically conductive layer is electrically connected to a counter-electrode in the at least one ionizer.

19. The air filter unit according to claim 18, wherein the electrical connection between the at least one electrically conductive layer and the counter-electrode in the ionizer is operable to be switched on and off, such that the at least one electrically conductive layer is configured to be disconnected from the counter-electrode after a predetermined polarization period has elapsed, and reconnected to the counter-electrode after a predetermined depolarization period has elapsed.

20. The air filter unit according to claim 17, wherein the at least one filter medium comprises a supporting layer on a downstream side of the at least one electrically conductive layer.

21. The air filter unit according to claim 17, wherein the at least one filter medium further comprises a cover nonwoven on an upstream side of the at least one outer electret layer.

22. The air filter unit according to claim 17, wherein the at least one electret layer comprises at least one outer electret stratum that comprises polyolefin fibers, wherein the at least one outer electret stratum comprises two different types of polymer fibers, a first of the two different types of polymer fibers is a polyolefin fiber, and the second of the two different types of polymer fibers is a fiber made of modified polyolefin, wherein the first polymer fiber type is a fiber containing polypropylene, and/or the second polymer fiber type is a fiber containing at least one of the following polymer materials: polyvinyl chloride, polytetrafluoroethylene, or a modacrylic.

23. The air filter unit according to claim 17, wherein the at least one outer electret layer further comprises at least one outer gradient stratum on the upstream side of the at least one outer electret layer, wherein the at least one outer gradient stratum comprises electrostatically charged polyolefin fibers.

24. The air filter unit according to claim 17, wherein the at least one mechanically filtering layer contains nanofibers, wherein the nanofibers have a diameter of approx. 10 nm to 800 nm, wherein the diameter of the nanofibers is preferably approx. 90 nm to 500 nm.

25. The air filter unit according to claim 17, comprising at least one intermediate layer between the at least one mechanically filtering layer and the at least one inner electret layer.

26. The air filter unit according to claim 17, wherein the at least one inner electret layer comprises at least one inner electret stratum comprising polyolefin fibers, wherein the at least one inner electret stratum comprises two different types of polymer fibers, wherein the first of the two different types of polymer fibers is a polyolefin fiber, and the second of the two different types of polymer fibers is a fiber made of modified polyolefin, wherein the first polymer fiber type is a fiber containing polypropylene, and the second polymer fiber type is a fiber containing at least one of the following polymer materials: polyvinyl chloride, polytetrafluoroethylene, or a modacrylic.

27. The air filter unit according to claim 17, wherein the at least one inner electret layer also has at least one inner gradient stratum on the upstream side of the at least one inner electret stratum, which preferably contains electrostatically charged polyolefin fibers.

28. The air filter unit according to claim 17, wherein the at least one electrically conductive layer is a gas adsorption layer.

29. The air filter unit according to claim 17, wherein the at least one electrically conductive layer comprises activated carbon.

30. The air filter unit according to claim 17, wherein the at least one electrically conductive layer comprises activated carbon and an ion exchanger.

31. The air filter unit according to claim 17, wherein the filter medium is pleated.

32. A use of an air filter unit according to claim 17 in a motor vehicle.

33. The air filter unit according to claim 24, wherein the nanofibers have a diameter of approx. 90 nm to 500 nm.
